(19) United States
(12) Patent Application Publication
(10) Pub. No.: US 2005/0087606 A1
(43) Pub. Date: Apr. 28, 2005

(54) Card edge marking

(75) Inventor: Roger D. McCumber, Minnetonka, MN (US)

Correspondence Address: MERCHANT & GOULD PC, P.O. BOX 2903, MINNEAPOLIS, MN, 55402-0903, US

(73) Assignee: DataCard Corporation, Minneapolis, MN (US)

(21) Appl. No.: 10/692,937

(22) Filed: Oct. 24, 2003

(51) Int. Cl. G06K 19/06

(52) U.S. Cl. 235/491

(57) ABSTRACT

A card having non-visible or visible communication markings provided on a portion of the card, preferably the perimeter edge surface of the card. When the communication markings are provided on the card edge surface, the markings can be either non-visible to the naked eye or visible to the naked eye. Non-visible markings can be formed on the edge surface using UV or IR ink printed using an ink-jet printer. The communication markings can be used to verify and track cards within card processing equipment, both prior to and during card personalization, as well as prior to or after attachment to mailer forms. The communication markings can also be used for security purposes in preventing card fraud.

### FIELD OF THE INVENTION

The invention relates to data bearing cards, such as credit cards, driver's licenses, identification cards and the like. More particularly, the invention relates to a new system to track such cards prior to and during card processing through use of non-visible or visible markings provided on a portion of the card, preferably a portion of the perimeter edge of the card, as well as to a card containing such markings, to the processing of such cards, and to various methods relating to the new system.

### BACKGROUND OF THE INVENTION

The use of data bearing cards, such as credit cards, driver's licenses, identification cards and the like, is well known. Typically, these cards are provided with information that is personal to the intended card holder, such as the card holder's name, address, account number, and picture. This personalized information can be provided as embossing on the card, printed onto the card, encoded on a magnetic stripe or programmed into an integrated circuit chip on the card, and combinations thereof. These cards also typically include various coatings or laminations that are intended to extend the life of the cards and protect the personalized information from degradation.

The personalized information, as well as laminations, are typically added to what will be referred herein as to pre-personalized cards using a card processing system. Many of these card processing systems are formed as modular systems composed of a plurality of separate modules, each of which is designed to perform a particular processing function or functions. The modules can be taken out of, or inserted into, the system so that the system can be adapted to the changing needs of the user. These system often include the capability of attaching one or more personalized cards to a mailer form for mailing to the card holder. Examples of modular card processing systems are the Maxsys system and the 9000 system, each of which is produced by DataCard Corporation of Minnetonka, Minn.

The pre-personalized cards are typically provided by a card manufacturer to a card production facility to personalize the pre-personalized cards using suitable card processing equipment. It is important that the correct pre-personalized card type be processed to include the proper personalization information, in order to prevent the card holder from being provided with an incorrect card type. For example, if a Visa brand card is to be personalized for a particular card holder, it is important to ensure prior to processing the card that the card about to be processed is actually a Visa brand card, and not a Mastercard or Discover brand card.

In addition, in modular card processing systems, it is important to prevent card holder information from being added to the wrong card. Conventional modular card processing systems rely upon system programming to provide correct timing and sequencing of cards as they progress through the various modules. Provided that there are no errors in the timing or sequencing, it is assumed that the proper card is in a particular module, and as a result that the card holder information is being added to the proper card. However, errors can occur that disrupt the timing and sequencing. If an error does occur, and the error is not discovered in time, the card holder information can be added to the wrong card.

Further, once a card has been personalized, it is important to ensure that the correct card (or cards) is being attached to the correct mailer form. It is known in the art to provide the mailer form with a printed bar code or a unique printed identifier which is read prior to or after attachment of the card to the form. It is also known to read information from the personalized card, such as reading the embossed characters or reading the magnetic stripe, prior to or after attaching the card to the form. The information obtained by reading the form is then compared with the information obtained by reading the card, and if it is determined that a match exists, then the determination is made that the proper card has been, or is about to be, attached to the proper form.

There has also been increasing use of security devices on plastic cards. These security devices are intended to provide some measure of security to prevent fraud after the card has been personalized. An example of such a security device is the use of holograms. However, additional security measures would be useful.

### SUMMARY OF THE INVENTION

The invention relates to a new system to verify and track cards within card processing equipment, both prior to and during card personalization, as well as prior to or after attachment to mailer forms. The invention also relates to cards that can be verified using this new system, the processing of such cards, producing cards that can be verified, and to various methods relating to the new system.

Card verification and tracking is implemented through the use of generally non-visible or visible indicia or encoding (collectively referred to as communication markings) provided on a portion of the card, preferably the perimeter edge of the card. When the communication markings are provided on the card edge, the markings can be either generally non-visible to the naked eye or visible to the naked eye. To provide non-visible markings, ultraviolet (UV) or infra-red (IR) inks can be used to form the markings. To provide visible communication markings, standard card printing inks can be used, or the markings can be formed through other means, such as by using a laser to create the markings. When the markings are provided on one of the major card surfaces, the markings are preferably non-visible to the naked eye to avoid interfering with the appearance of the card surface. The non-visible markings can be formed using ultraviolet (UV) or infra-red (IR) ink.

In a modular card processing system, suitable readers are provided to read the communication markings on the card. The readers can be provided at convenient locations within the card processing equipment where it is desired to verify or track cards. The readers can also be utilized separate from the card processing equipment to track cards prior to reaching the card processing equipment, or used by retailers and the like to read the markings for security purposes.

In one aspect of the invention, a card comprises first and second opposite major surfaces and a perimeter edge surface, and at least one communication marking provided on at least a portion of the perimeter edge surface.

In another aspect of the invention, an identity document comprises first and second opposite major surfaces and a perimeter edge surface, and at least one communication marking provided on at least a portion of the first major surface, the second major surface, or the perimeter edge surface, and the communication marking is formed from a non-visible ink.

In still another aspect of the invention, a method of creating a verifiable identity document comprises providing an identity document having first and second opposite major surfaces and a perimeter edge surface, and forming at least one communication marking on at least a portion of the perimeter edge surface.

In still another aspect of the invention, a method of verifying an identity document comprises forming at least one communication marking on at least a portion of a perimeter edge surface of the identity document, reading the communication marking, and based on the reading, determining whether the identity document is the proper document.

In still another aspect of the invention, a reader for reading a communication marking provided on at least a portion of a perimeter edge surface of a card comprises a housing, and a slot formed in the housing defining a card path along which at least a portion of the card, including the perimeter edge surface containing the communication marking, can travel. A light source provides light to the reading area, and a light receiver senses light that has been reflected from the perimeter edge surface.

For a better understanding of the invention, its advantages and objects obtained by its use, reference should be made to the drawings which form a further part hereof, and to the accompanying description, in which there is described a preferred embodiment of the invention.

### BRIEF DESCRIPTION OF THE DRAWINGS

FIG. 1 illustrates a data bearing card according to the invention.

FIG. 2 is view looking the direction of the arrow 2 in FIG. 1, showing the top edge of the card provided with non-visible communication markings.

FIG. 3 is a view similar to FIG. 2 but the card edge is provided with visible communication markings.

FIG. 4 is a schematic depiction illustrating how to print the non-visible communication markings of FIG. 2 onto the card edge.

FIG. 5 is a front view of a card reader for reading communication markings on the card edge.

FIG. 6 is a top view of the card reader.

FIG. 7 is a cross-sectional view of the reader taken along line 7-7 in FIG. 6 showing the light passages in the reader and the reading area.

FIG. 8 schematically depicts a modular card processing system.

### DETAILED DESCRIPTION OF THE INVENTION

The invention relates to a system to verify and track cards, particularly plastic cards, within card processing equipment, both prior to and during card personalization, as well as prior to or after attachment to mailer forms. The invention also relates to cards that can be verified using this new system, the processing of such cards, the production of cards that can be verified and tracked, and to various methods relating to the new system.

The concepts described herein can also be utilized to verify and track identity documents other than plastic cards, for example passports, within other identity document production equipment. The concepts described herein can also be utilized with respect to other types of cards, for example sports cards, during the production of such cards, as well as for security purposes with respect to such cards after the cards are produced.

The concepts of the invention will hereinafter be described with respect to data bearing plastic cards, such as credit cards, driver's licenses, identification cards and the like. However, it is to be realized that the concepts could be utilized with respect to other identity documents and identity document production equipment as well, as well as to other types of cards and card production equipment where it is necessary to ensure that the correct card is being processed and to track movements of the cards through the processing equipment.

The concepts described herein can also be used for fraud prevention and other security purposes after the card has been personalized. For example, the concepts described herein will permit a retailer who accepts payments by credit cards to determine whether the card being presented for payment purposes by the purported card holder is genuine or a forgery.

As used throughout this specification, plastic cards refers to cards such as credit cards, driver's licenses, identification cards and the like. Such cards are typically made of suitable plastics of a type well known in the art. However, the concepts described herein could also be used on cards made from materials other than plastics or combinations of plastics and other materials.

As used throughout this specification, communication marking(s) includes number(s), letter(s), symbol(s), bar code(s), other markings intended to communicate something to another or to direct someone to a location to access additional information, and combinations thereof.

### Card Edge Marking

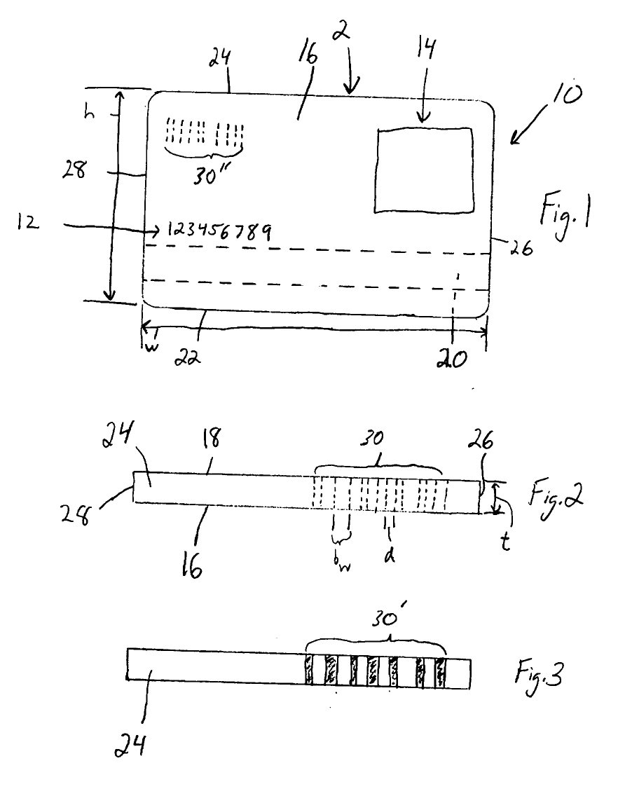

Turning now to FIG. 1, one specific implementation of the concepts of the invention will now be described. FIG. 1 illustrates a plastic card 10 that has been personalized with card holder information such as an account number 12 and a photograph 14. The card holder information is placed on a first major surface 16 of the card. The card 10 includes a second major surface 18 opposite the first surface 16, with the surface 18 having a magnetic stripe 20 upon which card holder information and other information can be encoded. The surfaces 16, 18 are generally planar, except that the account number 12, which is typically, but not always, embossed, and other card features and slight deviations in the card make the surfaces deviate somewhat from being completely planar.

The card 10 also includes a perimeter edge surface defined by a bottom edge surface 22, a top edge surface 24, a right side edge surface 26 and a left side edge surface 28. The card 10 is preferably a standard, CR80-sized card having a width w of approximately 3.375 inches (approximately 85.725 mm), a height h of approximately 2.125 inches (approximately 53.975 mm), and a thickness t of approximately 0.03 inches (approximately 0.762 mm). However, cards having other dimensions could also be used, including non-standard sized cards and irregular shaped cards each of which is disclosed in U.S. Pat. No. 6,471,127.

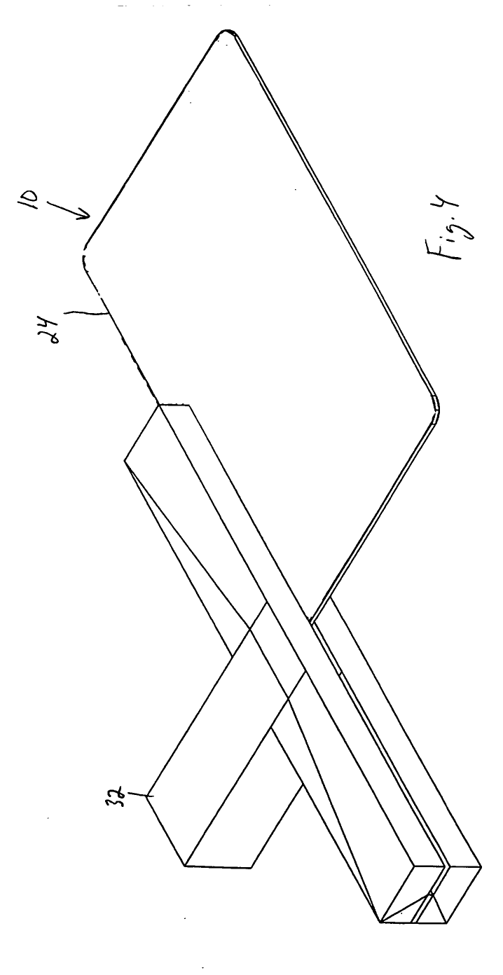

With reference to FIG. 2, the top edge 24 of the card is provided with non-visible communication markings 30. The thickness of the edge 24 in FIG. 2 has been greatly exaggerated in order to permit illustration and explanation of the card edge communication markings. The markings 30 have been illustrated in dashed lines to highlight that the markings 30 are non-visible, i.e. not readily visible to the naked eye. Instead, a suitable reader (to be later described) must be used in order to read the markings.

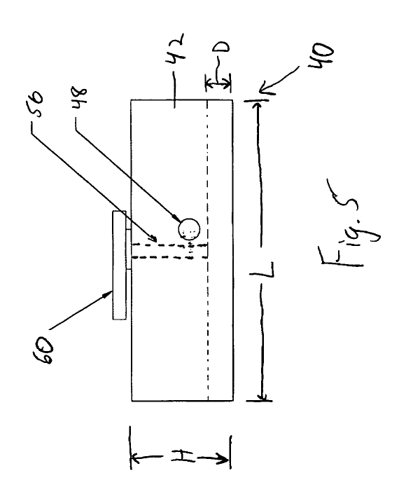

FIG. 3 illustrates a variation in which the top edge 24 of the card is provided with visible communication markings 30′. In this case, the markings 30′ are illustrated in solid lines to highlight that the markings 30′ are visible to the naked eye, and the markings 30′ can be read by a person without the aid of a reading device or via a conventional reading device, such as a bar code reader (when the markings 30′ used are a bar code), of a type known in the art.

Regardless of which type of markings 30, 30′ are used, the markings 30, 30′ preferably provide information that permits the card to be verified and tracked both prior to being processed in a card processing machine, as well as within the card processing machine. In the preferred embodiment, the markings 30, 30′ are a bar code, preferably Code 39 bar code. The markings 30, 30′ can also comprise numbers, letters, symbols, marks, other markings intended to communicate something to another or to direct someone to a location to access additional information and combinations thereof. A single marking can be used, or multiple markings can be provided.

For card verification and tracking purposes, the information contained in the markings 30, 30′ can comprise information as to the type of card the markings are provided on, a sequence number, and other information pertaining to card processing. If the markings are used for additional purposes, such as fraud prevention, the markings can also convey information used for security purposes, for example information pertaining to the original card holder or a unique security identifier.

When the markings 30 are a bar code and the markings are non-visible, it has been found that bars having a minimum width b_{w} of approximately 0.05 inches (approximately 1.27 mm) and a distance d between the bars of at least approximately 0.05 inches (approximately 1.27 mm), as shown in FIG. 2, can be used. When the markings 30′ are visible, it has been found that bars having a minimum width b_{w} of approximately 0.01 inches (approximately 0.254 mm) and a distance d between the bars of at least approximately 0.01 inches (approximately 0.254 mm) can be used.

The markings 30, 30′ can be disposed anywhere along the length of the top edge 24, but should be placed far enough from the rounded corners of the card so that the rounding does not interfere with reading the markings. In addition, the markings 30, 30′ generally extend from surface 16 to surface 18 on the edge 24. However, the markings need not extend completely between the surfaces 16, 18.

Further, the markings can be placed on one or more of the bottom edge 22 or side edges 26, 28 rather than along the top edge 24, or on one or more of the edges 22, 26, 28 in addition to the top edge 24. As shown in FIG. 1, markings 30″ could also be located on the major surface 16 (or on the major surface 18). If there are markings 30″ on the major surface 16, the markings 30″ are preferably non-visible (similar to the markings 30) so that the markings 30″ have minimal or no impact on the resulting visual appearance of the card after the card has been processed.

### Producing the Markings

The non-visible markings 30 can be produced using UV ink or IR ink, each of which is known in the art. A suitable for use in practicing the invention is Hewlett-Packard UV/IR ink. The ink can be printed onto the card edge 22 using an ink jet print head, such as an HP Model 45 print head. With reference to FIG. 4, the printer should be configured such that the print head 32 faces toward the top edge 24. The print head 32 of the printer can then be operated to print the markings onto the edge 24. If the markings are to be placed onto a different card edge, or onto a major surface of the card, the print head location would change to accomplish the necessary printing task.

By using non-visible UV or IR ink, the printed markings 30 are not readily visible to the naked eye, but can be read using a suitable UV or IR reader. Further, by printing the UV or IR ink onto the edge, the markings will not detract from the visual appearance of the major surfaces of the card.

Visible markings can be produced using conventional inks used in card processing. Alternatively, the visible markings can be produced using a laser beam projected onto the appropriate card edge. The laser beam scores the card edge and at the locations of the scoring, alters the color of the plastic. The use of lasers in laser personalization of cards and the process by which a laser generates personalization information on a card is well known to persons of ordinary skill in the art.

In one embodiment, the communication markings are printed or otherwise formed on the card by the manufacturer of the pre-personalized card. In this way, one can read the communication markings while the cards are in, or have just left, the input hopper of the card processing system, so that the type of card to be processed is known. In another embodiment, the communication markings can be printed or otherwise formed on the card after the card has left the input hopper. Further, additional communication markings to those already provided on the card by the card manufacturer can be formed on the card.

To form the markings within the card processing equipment, the appropriate equipment, for example the ink jet printing mechanism, can be located within one of the modules of the card processing equipment. Alternatively, the equipment can be provided as a separate module within the card processing equipment.

### Reading the Markings

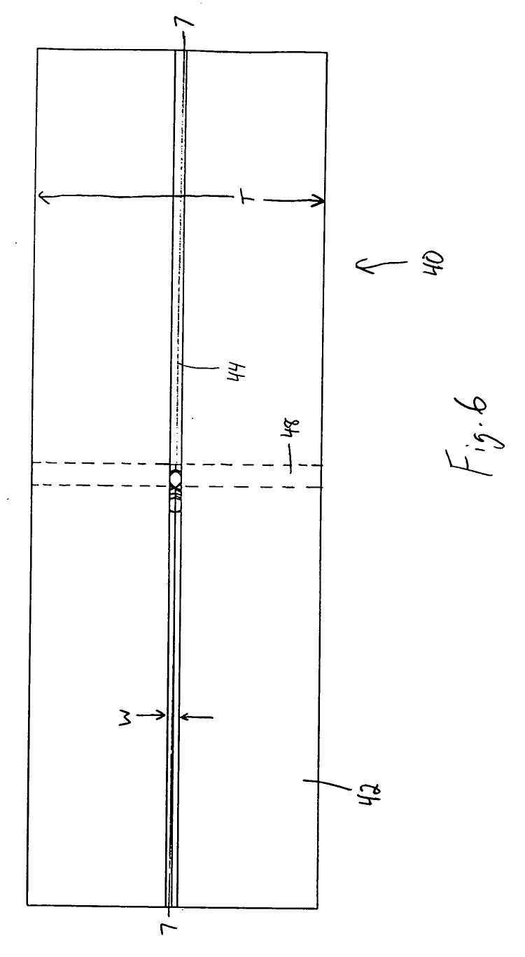

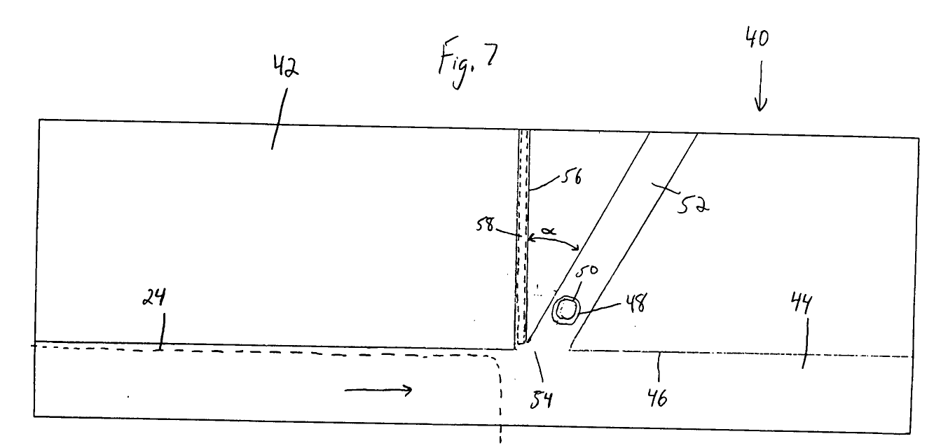

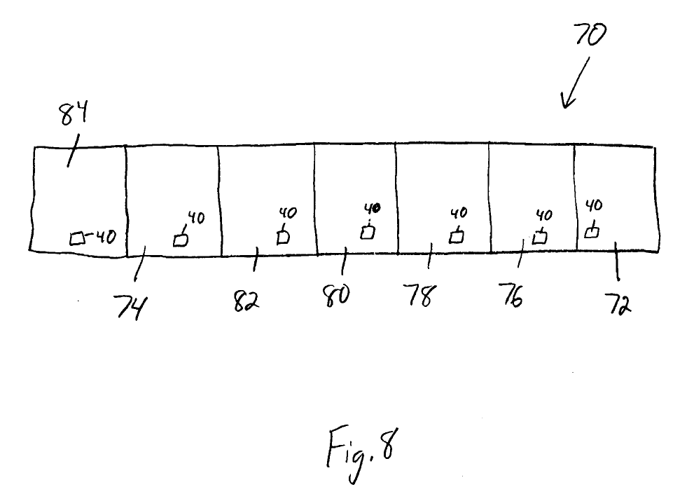

To read the communication markings, suitable equipment is provided. To read the markings 30, a UV or IR reader 40, shown in FIGS. 5-7, can be used. The reader 40 comprises a housing 42 that includes a slot 44 extending therethrough. The slot 44 defines a card path along which the top portion of the card (or other portion if the markings are provided on another portion of the card) travels. FIG. 7 shows a top wall 46 of the slot 44 along which the top edge 24 of the card 10 will travel as it moves through the housing 42.

With reference to FIGS. 5-7, the housing 42 includes a channel 48 extending therethrough from one side wall to the opposite side wall. A light source 50 is disposed with the channel 48 for illuminating the markings 30. A second channel 52, shown in FIG. 7, extends from the top of the housing 42 to the slot 44, intersecting the channel 48. The second channel 52 is provided to permit light from the light source 50 to flood a reading area 54, where the reading of the markings 30 occurs, with light. The housing 42 further includes a third channel 56 extending from the reading area 54 to the top of the housing 42. A fiber optic tube 58 is disposed in the channel 56 and directs light that has been reflected from the card edge to a sensor 60.

When UV ink is used, it has been found that the light source 50 can be a UV tube such as a UV lamp, model BF325-UV1, available from JKL Components Corp. of Pacoima, Calif. The UV lamp produces UV light in the range of about 300 to about 400 nanometers, with a peak of about 365 nm. The sensor 60 can be a UV sensor, model BS120, available from Sharp Electronics, Inc., having a sensitivity of about 300 nm to about 700 nm, with a peak of about 560 nm.

In the case of markings 30, 30″ formed by IR ink, the light source 58 is preferably an IR source, for example a light emitting diode (LED) producing IR light in the range of about 800 nm to about 1000 nm, with a peak of about 850 nm. The receiver 60 is preferably an IR receiver capable of receiving reflected IR light from the source 58. IR sources and receivers are well known in the art.

In the case of visible markings 30′, the light source 58 can produce visible light while the receiver 60 can be, e.g., a photodiode which picks up reflected light from the markings 30′. Therefore, if the markings 30′ are a bar code, the source 58 and receiver 60 function similarly to a conventional bar code scanner.

It is to be realized that other light sources and light receivers could be used in place of the sources and receivers discussed above.

The reader 40 functions as follows. Assuming the use of UV ink and a UV light source, light from the light source 50 floods the reading area 54 with UV light. As the card travels through the slot 44, the light from the UV source impinges on the top edge 24 of the card. The markings absorb light at one wavelength, for example about 375 nm, and emit light at a second wavelength, for example about 430 nm. The emitted light enters the fiber optic tube 58 and is picked up by the sensor 60. In this manner, the markings and any information provided thereby, are determined.

To enhance the amount of light reaching the reading area 54, the upper portion of the channel 48 can be provided with a reflective material to reflect additional light toward the reading area 54.

As shown in FIG. 7, the channel 52 is disposed at an acute angle α relative to the channel 56. The angle α can be between about 45 and about 90 degrees, and is preferably about 45 degrees.

The housing 42 can be made of a metallic material, for example aluminum, in order to avoid deterioration from the UV light. Further, the fiber optic tube 58 is preferably made of glass to avoid deterioration from the UV light. The housing 42 can have a total length L of about 3.0 inches, a height H of about 1.0 inch, and a thickness T of about 1.0 inch. The depth D of the slot 44 is about 0.250 inch, with a width W of about 0.040 inch.

The housing 42 illustrated in FIGS. 5-7 provides a sufficiently dark reading area 54 to minimize stray light from detracting from the reading of the markings. Further, the reader 40 is sufficiently small to permit the reader to be installed into existing card processing equipment while minimizing the alterations that may be necessary to accommodate the reader 40. Other reader shapes and sizes, and other housing materials, may be used as well.

### Card Processing Systems

The card processing systems with which the concepts described herein can be used includes those systems that process data bearing plastic cards, such as credit cards, driver's licenses, identification cards and the like. The concepts have particular use in modular card processing systems, for example the Maxsys system available from DataCard Corporation of Minnetonka, Minn., or the system disclosed in U.S. Pat. No. 5,266,781.

FIG. 8 schematically illustrates a modular card processing system 70. The system 70 would typically include an input hopper module 72 for holding pre-personalized cards waiting to be processed and personalized. The system 70 would also typically include an output hopper module 74 that receives personalized cards as well as reject cards. Between the input hopper 72 and the output hopper 74, the system 70 can include various modules for performing personalization and other processing functions on the cards. For example, the system 70 can include a magnetic stripe encoding module 76 that encodes the magnetic stripe on the card (if a magnetic stripe is present), a printing module 78 for performing various printing functions on the card, a laser personalization module 80 for performing laser personalization, and an embossing module 82 for producing embossing of such information as the card holders account number. The order of the modules 76-82 is meant to be exemplary only; the modules 76-82 could be arranged in other orders, and one or more additional processing modules could be provided in the system as well.

As FIG. 8 also illustrates, one or more of the readers 40 can be provided in or adjacent each module 72-82. With respect to the input hopper module 72, the reader 40 is preferably positioned to read the markings of a card that has been picked for further processing. Prior to processing, the reader 40 reads the communication markings to verify that the proper card type has been picked and is about to be personalized.

With respect to the output hopper module 74, the reader 40 is preferably located to be able to read the communication markings to verify that the expected card has been received. In the modules 76-82, the readers 40 are preferably located so as to read the communication markings to verify that the proper card is within the particular module.

The system 70 can also include mailer and inserter capability, represented by 84. The mailer and inserter is designed to take one or more personalized cards, affix them to a printed mailer form, fold the form, and insert the form in an envelope ready for mailing to the intended card holder. Mailer and inserter mechanisms are well known in the art. It is important that the proper card(s) be attached to the proper form to prevent cards from being sent to the incorrect card holder.

The mechanism 84 can include a reader 40 that reads the communication markings on the card, preferably prior to attaching the card to the mailer form. The information obtained from reading the communication markings can then be compared to information obtained from reading the mailer form. If it is determined that a match exists between the information, the mechanism can then proceed to attach the card to the form to be mailed to the card holder.

Card processing systems other than modular systems can benefit from the concepts described herein. For example, table top card personalization machines could read communication marking on cards to ensure that the proper card type is being personalized.

In addition, the concepts described herein could be used in other equipment where it is necessary to verify that processing operations are to begin on the correct object, and to track and verify movements of an object as it progresses through various processes. For example, the concepts described herein could be used on passports and equipment used to produce passports.

### Security/Fraud Prevention Measures

In addition to verification prior to and during processing, and prior to or after attachment of the card to a mailer form, the communication markings can also be used for security purposes, for example preventing fraud. The communication markings provide a means to help a merchant, retailer, etc. determine at the point of sale whether the card itself has been altered or help determine that the proper card holder is presenting the card.

If the markings are not present on the card, that could indicate that the card has been tampered with or is a fake. Further, if the markings provide information that is inconsistent with the card holder information on the face of the card, that could indicate that the card has been tampered with. It is preferred that the security communication markings be provided in non-visible UV or IR ink, preferably on the card edge surface.

The communication markings used for security purposes can be the same as, or similar to, the markings 30, 30′, 30″ and provide similar information when the markings are read. Alternatively, communication markings for security purposes can be different from the markings 30, 30′, 30″, and provide different information that the markings 30, 30′, 30″. For example, the communication markings used for security can be a security code, which if not present on the card would provide an indicator of possible fraud. Security communication markings can be added to the card at the same time as the markings 30, 30′, 30″, or in a separate step during card processing.

The above specification, examples and date provide a complete description of the invention. Many embodiments of the invention, not explicitly described herein, can be made without departing from the spirit and scope of the invention.

1. An identity card comprising:
first and second opposite major surfaces and a perimeter edge surface, at least one of the major surfaces including card holder information, and at least one communication marking provided on at least a portion of the perimeter edge surface to enable the card to be tracked within card processing equipment, wherein the communication marking is formed from non-visible ink.

2. The card of claim 1, wherein the perimeter edge surface comprises a top edge surface, and the communication marking is provided on at least a portion of the top edge surface.

3. The card of claim 1, comprising a plurality of the communication markings.

4. The card of claim 3, wherein the communication markings comprise a bar code.

5. The card of claim 1, wherein the communication marking comprises a number, a letter, or a symbol.

6. (canceled)

7. The card of claim 1, wherein the non-visible ink comprises UV or IR ink.

8. (canceled)

9. (canceled)

10. An identity document, comprising:
first and second opposite major surfaces and a perimeter edge surface, at least one of the major surfaces including information relating to the intended holder of the identity document, and at least one communication marking provided on at least a portion of the perimeter edge surface to enable the identity document to be tracked within identity document processing equipment, and the communication marking being formed from a non-visible ink.

11. The identity document of claim 10, wherein the perimeter edge surface comprises a top edge surface, and the communication marking is provided on at least a portion of the top edge surface of the perimeter edge surface.

12. The identity document of claim 10, further comprising a communication marking is provided on at least a portion of the first major surface.

13. The identity document of claim 10, comprising a plurality of the communication markings.

14. The identity document of claim 13, wherein the communication markings comprise a bar code.

15. The identity document of claim 10, wherein the communication marking comprises a number, a letter, or a symbol.

16. The identity document of claim 10, wherein the non-visible ink comprises UV or IR ink.

17. The identity document of claim 10, wherein the document comprises a card or a passport.

18. (canceled)

19. (canceled)

20. (canceled)

21. (canceled)

22. (canceled)

23. (canceled)

24. A method of verifying and tracking an identity card in equipment that is used to process identity cards, the equipment including an input that holds a plurality of identity cards to be processed and at least one piece of card processing equipment configured to perform a processing operation on the identity cards, comprising:
picking an identity card from the input;
prior to processing the picked identity card in the piece of card processing equipment, reading a communication marking provided on at least a portion of a perimeter edge surface of the identity card;
determining, based on reading the communication marking, whether the picked identity card is the expected identity card; and
if the picked identity card is the expected identity card, processing the picked identity card in the piece of card processing equipment.

25. The method of claim 24, comprising reading the communication marking while the card is in the input prior to picking.

26. The method of claim 24, comprising reading the communication marking after the card has been picked from the input.

27. The method of claim 26, comprising reading the communication marking as part of a determination as to whether the card is to be affixed to a mailer form.

28. A reader for reading a communication marking provided on at least a portion of a perimeter edge surface of a card, comprising:
a housing;
a slot formed in the housing defining a card path along which at least a portion of the card, including the perimeter edge surface containing the communication marking, can travel;
a reading area defined in the slot at which the communication marking can be read;
a first channel intersecting the slot at the reading area at an acute angle relative to a longitudinal axis of the slot;
a light source positioned in the first channel to provide light to the reading area; and
a light receiver positioned to sense light that has been reflected from the perimeter edge surface.

29. The reader of claim 28, wherein the light source is an ultraviolet light source providing ultraviolet light.

30. The reader of claim 29, wherein the light receiver is an ultraviolet light sensor.

31. The reader of claim 29, further comprising a second channel intersecting the slot at the reading area, wherein light that has been reflected from the perimeter edge surface enters the second channel, and the second channel has an axis that is disposed generally perpendicular to the longitudinal axis of the slot.

32. A card processing system, comprising:
an input that holds a plurality of identity cards to be processed, each card having first and second opposite major surfaces, a perimeter edge surface and at least one communication marking provided on at least a portion of the perimeter edge surface;
at least one piece of card processing equipment configured to perform a processing operation on the cards; and
a reader for reading the communication marking provided on the perimeter edge surface of each card.

33. The card processing system of claim 32, wherein the reader is positioned to read the communication marking on each card while each card is within the input.

34. The card processing system of claim 32, wherein the reader is positioned to read the communication marking on each card after each card has left the input.

35. The card processing system of claim 32, comprising a plurality of pieces of card processing equipment, each piece of equipment is configured to perform a different card processing operation.

36. The card processing system of claim 35, comprising a reader associated with each piece of card processing equipment.

37. The card processing system of claim 32, wherein the card processing equipment comprises a magnetic stripe encoder, a printer, a laser, an embosser, a device for programming an integrated circuit chip, or a mechanism to attach the cards to forms.
